(19) United States
(12) Patent Application Publication
(10) Pub. No.: US 2008/0262960 A1
(43) Pub. Date: Oct. 23, 2008

(54) Automated Electronic Commerce Data Extracting and Analyzing System

(76) Inventors: Wade Malone, Atlanta, GA (US); Tze Ming Ku, Atlanta, GA (US); Stephen Herbst, Atlanta, GA (US); Robert Frohwein, Atlanta, GA (US)

Correspondence Address: MUSKIN & CUSICK LLC, 30 Vine Street, SUITE 6, Lansdale, PA, 19446, US

(21) Appl. No.: 12/104,346

(22) Filed: Apr. 16, 2008

Related U.S. Application Data
(60) Provisional application No. 60/912,666, filed on Apr. 18, 2007.

(51) Int. Cl. G06Q 30/00

(52) U.S. Cl. 705/37

(57) ABSTRACT

A method, apparatus, and computer readable storage to implement an automatic e-commerce site monitoring system. Data can be automatically gathered from online e-commerce sites such as online auctions and analyzed and stored in a database. A merchant can query the database to find all e-commerce sites selling their products. Suspicious transactions can automatically be identified to the merchant who then may have the option to shut down the particular offending sales. A suspicious transaction may be one that has characteristics likely of some prohibited activity, such as selling counterfeit or grey market goods.

### CROSS REFERENCE TO RELATED APPLICATIONS

This application claims benefit to provisional application 60/912,666, which is incorporated by reference herein in its entirety.

### BACKGROUND OF THE INVENTION

1. Field of the Invention

The present inventive concept is directed to a method, apparatus, and computer readable storage medium to automatically monitor and retrieve relevant data from online auctions, parse and analyze that data to identify particular auctions which may involve particular kinds of conduct.

2. Description of the Related Art

Online auctions and other e-commerce sites online are a major avenue that many companies and individuals currently use to sell their products. Many illegal or undesirable activities are currently taking place on these sites. Some examples of such activity are selling counterfeit or grey market goods, selling items in bulk in violation of manufacturer restrictions, and other activities.

Merchants whose products are being sold on online auctions and other e-commerce sites have a clear interest in protecting their products from any activity that may ultimately hurt their company (and potentially their loyal customers users as well). Merchants that wish to police online commerce sites for undesirable activities relating to their products face a daunting task, especially since there are many major online commerce sites currently in operation.

What is needed is an easy way for a merchant to monitor and address undesirable sales of their products (or counterfeit products) on such online commerce sites. Once prohibited sales are identified, then further measures can be taken to shut down the particular sales.

### SUMMARY OF THE INVENTION

It is an aspect of the present inventive concept to provide an apparatus, method, and computer readable storage medium to monitor and analyze items for sale on electronic commerce web sites such as auctions.

The above aspects can be obtained by a method that includes (a) automatically visiting at least one online auction site using a robot and automatically retrieving auction data from the at least one online auction site, the auction data comprising individual sales and their respective sales information, and storing the auction data in a database; (b) receiving sales properties from a user; and (c) retrieving a subset of the sales data from the database based on the properties and displaying the subset to the user.

The above aspects can also be obtained by a method that includes (a) reviewing first data comprising information on a first online sale offer offered by a username; and (b) applying rules to the first data and additional sales data stored in a database to determine a warning level for the first online sale offer, the additional sales data comprising data describing transactions aside from the first online sale offer.

The above aspects can also be obtained by a method that includes (a) automatically visiting an online auction site and automatically retrieving individual auction data for an individual auction; (b) ascertaining a seller of the individual auction; (c) determining that the seller is not in a database storing auction data; (d) automatically placing a nominal bid on an item for auction in the individual auction; (e) receiving additional seller data from the online auction site; and (f) storing the additional seller data in the database.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present inventive concept, as well as the structure and operation of various embodiments of the present inventive concept, will become apparent and more readily appreciated from the following description of the preferred embodiments, taken in conjunction with the accompanying drawings of which:

FIG. 1 is a block diagram illustrating exemplary components used in a an e-commerce data extracting and analyzing system, according to an embodiment;

FIG. 2 is a flowchart illustrating an exemplary method of extracting data from e-commerce systems and storing them, according to an embodiment;

FIG. 3 is a first output illustrating an exemplary presentation of auction data stored in a database, according to an embodiment;

FIG. 4 is a second output illustrating an exemplary presentation of auction data stored in a database, according to an embodiment;

FIG. 5 is a flowchart illustrating an exemplary method of outputting auction data from a database, according to an embodiment;

FIG. 6 is a flowchart illustrating an exemplary method of shutting down auctions, according to an embodiment;

FIG. 7 is a flowchart illustrating an exemplary method of using additional information aside from the seller's auction description in order to apply rules, according to an embodiment;

FIG. 8 is an exemplary flowchart illustrating a method of making nominal bids in an auction in order to extract seller data, according to an embodiment;

FIG. 9A is a flowchart illustrating an exemplary method of associating status indicators with auctions, according to an embodiment; and

FIG. 9B is a flowchart illustrating an exemplary method of implementing a time sensitive status indicator, according to an embodiment.

### DESCRIPTION OF THE PREFERRED EMBODIMENTS

Reference will now be made in detail to the presently preferred embodiments of the inventive concept, examples of which are illustrated in the accompanying drawings, wherein like reference numerals refer to like elements throughout.

The inventive concept relates to an apparatus, method, and computer readable storage medium to implement an automated (with little or no human interaction required) method wherein a company can monitor products being sold at one or more online auction sites or any other type of e-commerce site. Typically, a company would be interested in monitoring their own products being sold or monitoring potential counterfeits of their products. A company may also be interested in monitoring sales of their competitors as well.

The system can automatically visit one or more online auction sites, retrieve relevant information, store the relevant information in a database, and then analyze the relevant information in order to identify which individual auctions may be of interest to the company. An auction site can be a web site wherein participants can place items for sale and potential buyers bid on the items electronically. An e-commerce site is any site which allows for electronic buying and selling of items, which includes auction sites.

For example, the ACME Company sells widgets. ACME is facing a counterfeit widget problem, many of which are being sold on the e-ray auction site. The widgets are being advertised as the real thing and potential buyers have no way to determine online whether the widgets are genuine ACME widgets. If they purchase such a widget and receive it shipped to them, only then can the purchaser possibly tell that the widget is counterfeit. However, many such purchasers either would not (or cannot) discern that their widget is counterfeit, or perhaps don't care. If a purchaser is unhappy with the widget the original seller of the counterfeit widget may even refuse to take it back.

A method according to the present inventive concept can automatically visit the e-ray auction site and retrieve summaries about all of the auctions that are selling ACME widgets. This can be accomplished by visiting the e-ray site using a robot user, automatically entering in a search query for “ACME” and “widget,” and then gathering all of the results (using techniques such as “screen scraping” or html parsing). The results can then be stored in a database, such as an SQL based database. Each individual auction can contain a summary in the database, which comprises some or all of the information that the e-ray site had about it. Such information can be, for example: sellers name and info, item name, seller's address, price, item description, bidders and their history, etc.

Now the database contains auction data comprising summaries of all auctions that the robot found which are for ACME widgets. This data can now be analyzed according to a set of rules to determine which, if any, of these auctions are selling (or likely to be selling) counterfeit widgets. The counterfeit widget auctions may be identified in number of manners. For example, if a price of the widget is well below a market value, then it may be likely that the widget is counterfeit. If a previously identified seller of counterfeit goods is selling the widget, then it also may be likely that the widget is counterfeit. If there is text in the item description that can not be an accurate description of the widget, for example if the description of the widget in the auction states that the ACME widget is a “gold widget,” but the ACME company does not even make gold widgets, then the widget must be counterfeit.

Not all counterfeit widgets can be identified by the data that is available on the auction site, but nevertheless the more detailed a set of rules that is applied to the auction summaries, the better the results can be. In addition to the data available on the auction site, patterns of use can also be gathered, stored, and analyzed in order to also facilitate in the detection of undesirable characteristics. For example, consider an auction of an original autographed poster that uses a particular image file (e.g., the .JPG of the poster), and then after a buyer wins and the auction is completed, the same seller offers another original autographed poster using the same image file. Either the original sale was never completed (or the original buyer returned the item), or the seller is selling another “original autographed poster,” that looks exactly the same as the prior one, which means the autographed poster is likely a reproduction not an original.

Thus, in addition to analyzing individual auction summaries, auction behavior can be monitored and stored as well in order to identify undesirable characteristics of an auction. For example, all auctions of a particular seller can monitored and analyzed according to a set of rules. The application of rules to determine whether a particular auction is involved in undesirable activity is not limited to the information about that particular auction, but any other data the database may be relevant and can be used as well.

An “undesirable” or “irregular” characteristic means any characteristic that is indicative that activity unfavorable to a subject company might be more likely to be taking place. The undesirable characteristic does not necessarily imply that the unfavorable activity is definitely taking place, but only that it might be a warning sign. An undesirable characteristic may be found in an individual action summary, a pattern of behavior by a particular seller, or any other conduct taking place at an online merchant site that may indicate that something undesirable to a particular party may be more likely to be taking place. It is possible that an auction may have a lot of undesirable characteristics (according to a set of rules) but nevertheless there is nothing wrong with the auction at all.

Once auction data has been gathered from one or more auction sites, then the data can be analyzed according to a set of current rules and associated with warning levels. If an individual auction is determined to be suspicious then it can be associated with a respective warning level. Different warning levels can be used corresponding to a different level of confidence. For example, a low warning level can be used if an auction contains one or more irregularities which have some but not a high correlation to unfavorable (or prohibited activity). For example, if an auction is selling slightly below market price, this may be unusual, but probably not related to a prohibited activity since the markets may not be entirely efficient. A higher warning level can be used if an auction contains irregularities that more highly correlated to unfavorable or prohibited activity. For example, if a seller on e-ray is already known by the system to have sold counterfeit items in the past, then all auctions by this seller may be flagged with a high warning level flag since a past counterfeiter is very likely to continue selling further counterfeit goods.

A list of auctions can be generated that have a predetermined warning level of suspicion associated with them.

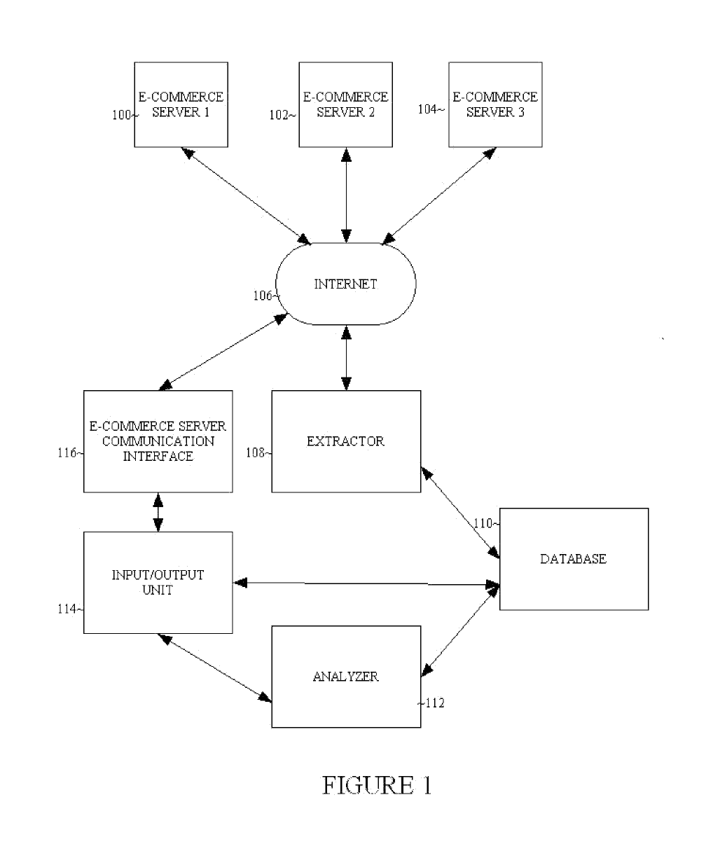

FIG. 1 is a block diagram illustrating exemplary components used in an e-commerce data extracting and analyzing system, according to an embodiment.

E-commerce server 1 100, e-commerce server 2 102, and e-commerce server 3 104 all serve different e-commerce sites which can be an online auction (e.g., E-BAY), an online store (e.g., AMAZON.COM), a services market (e.g., E-LANCE.COM) or any other site in which people can visit using a computer communications network such as the Internet 106 and buy and/or sell products or services.

An extractor 108 is used to automatically visit any combination of the e-commerce sites served by the e-commerce servers. The extractor can comprise a computer which is connected to the internet 106 (or other computer communications network) with a “robot” which can visit web sites automatically. The robot can store URLS of different e-commerce sites and automatically visit these sites by connecting with their respective hosts (or servers) using a computer communications network such as the Internet. Data retrieved from the hosts can be indexed and stored in a database. Data can be stored in numerous ways. For example, the raw screen images can be captured and saved (e.g., in JPG form) for later parsing and analysis. Alternatively, all html data can be saved for later parsing and analysis. Alternatively, the extractor can identify only targeted data (e.g., actual auction summaries) and store the auction summaries in the database 110. The robot browser can “crawl” the auction sites retrieving, indexing, and storing all data it comes across, or only data that is relevant to the user (e.g, by limiting data retrieved to those containing particular keywords, etc.)

Note that methods described herein apply not only to online auction sites but any type of commerce site as well. Thus, “auction data” can also be considered “sales data,” and any information related to a sale on an e-commerce site can be considered sales data. Auction data or sales data included any transactions known to the database, including open auctions or sales offers, close auctions or completed sales, or any other transaction information. The concepts of an auction on an auction site and a sale on an e-commerce site (but not an auction site) can be considered and used interchangeably herein.

An analyzer 112 can retrieve data from the database 110 and analyze the data by applying rules to the data. Rule sets can also be retrieved from the database 110 (or any other storage). The analyzer applies the rules to each individual auction summary. The results of the application determine whether the individual auction summary is flagged (or tagged) with a tag which represents irregular activity. The analyzer can either tag individual auction summaries stored in the database 110 and/or the analyzer can generate a separate list of irregular auctions (which can also be stored in the database 110 or other storage) with associated tags.

An input/output unit 114 can receive data from the analyzer 112 (or rules engine) and/or the database to display data to the user. The user can also identify particular data that the user wishes to view, upon wish the input/output unit 114 can query the database to retrieve the particular data and output the data to the user.

An e-commerce server communication interface 116 can be used to communicate with e-commerce servers. In some cases, e-commerce servers can be contacted to shut down particular offending auctions. The e-commerce server communication interface 116 can communicate with any e-commerce server (e.g., 100, 102, 104, or others) in order to request particular auctions to be shut down. Thus can be done automatically or upon manual request by the user.

It is noted that the components in FIG. 1 are illustrated in one particular arrangement, however it can be appreciated that the operations described herein and the respective hardware used to implement those operations can be arranged in numerous other configurations as well. For example, the entire system can run on a single computer (thus the individual blocks may not actually exist separately) or multiple computers/processors can implement different operations therein. A single database 110 can be used to store any data needed by the system, or multiple databases can be used. Components can be located physically together or in different locations connected by any kind of computer communications network.

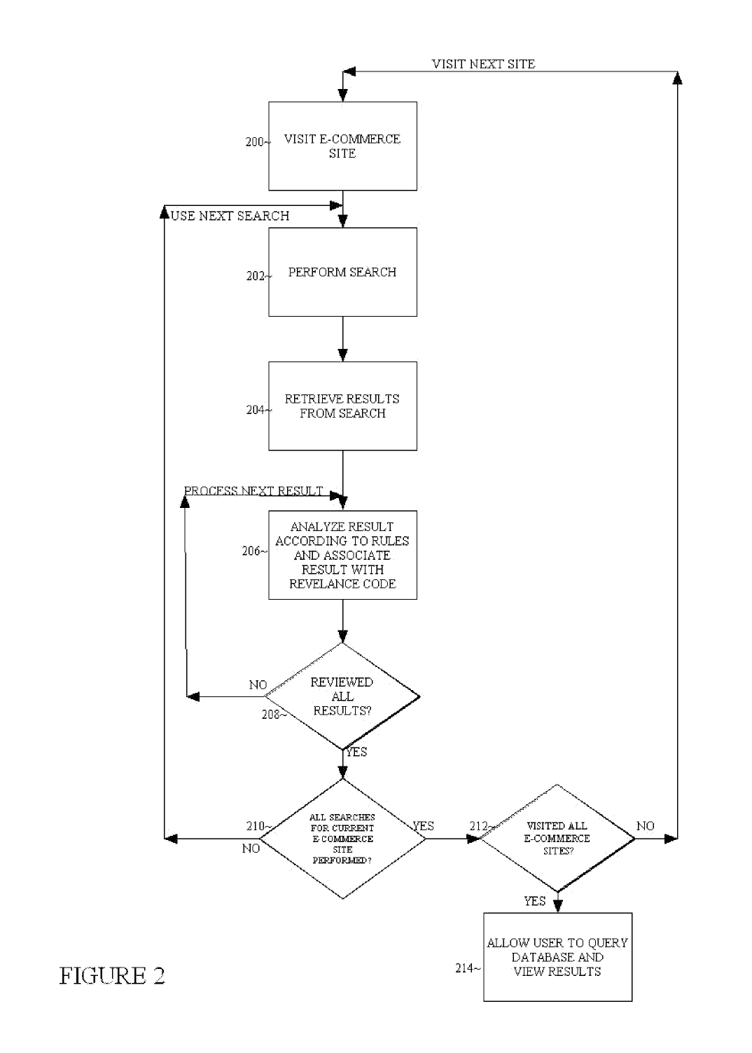

FIG. 2 is a flowchart illustrating an exemplary method of extracting data from e-commerce systems and storing them, according to an embodiment.

The method can start with operation 200, which visits an e-commerce site. This is typically done using an automated robot. A URL is automatically entered into a web browser (real or virtual), which visits the e-commerce site (actually communicates with the site's respective server or host).

From operation 200, the method can proceed to operation 202, which performs a search on the e-commerce site. This can, for example be a keyword search. Alternatively, an actual search may not be performed but instead the robot would know which links to click to achieve a particular listing. For example, a site may allow a user to navigate a series of menus or links to pull up a list of “real estate” for auction without actually having to type in anything.

From operation 204, the method can proceed to operation 204, which retrieves results from the search. This can be done by screen scraping or actually retrieving the html data that is intended to be displayed on the robot's browser. The html data actually contains the text describing all of the auction information and any links to image files (which can also be retrieved and stored in the auction summary.

From operation 204, the method can proceed to operation 206, which analyzes the result according to preset rules and associated a result of the analysis with a relevance code. The relevance code (or tag) can be associated with the auction summary in the database (e.g., by having a field in the record for a possible relevance code).

From operation 206, the method can proceed to operation 208, which determines whether all results have been reviewed. If not, then the method can return to operation 206, which processes the next result that was retrieved from operation 204.

If the determination in operation 208 determines that all results have been reviewed, then the method can proceed to operation 210, which determines whether all searches for the current e-commerce site have been performed. If not, then the method can return to operation 202 which uses a next search. The searches used for each respective e-commerce site can be prestored.

If the determination in operation 210 determines that all searches for the current e-commerce site have been performed, then the method can proceed to operation 212 which determines whether all of the targeted e-commerce sites have been visited. If not, then the method can return to operation 200, which visits a next targeted site.

If the determination in operation 212 determines that all of the targeted e-commerce sites have been visited, then the method can proceed to operation 214, which allows the user to query the database and view the results.

Once the data is in the database, and the warning levels have been associated with each auction, the data is ready for viewing by a user. An interface can be implemented to allow each user a pleasing and visually intuitive interactive experience so that the user can view the information he or she wishes to view and take any actions in an easy manner.

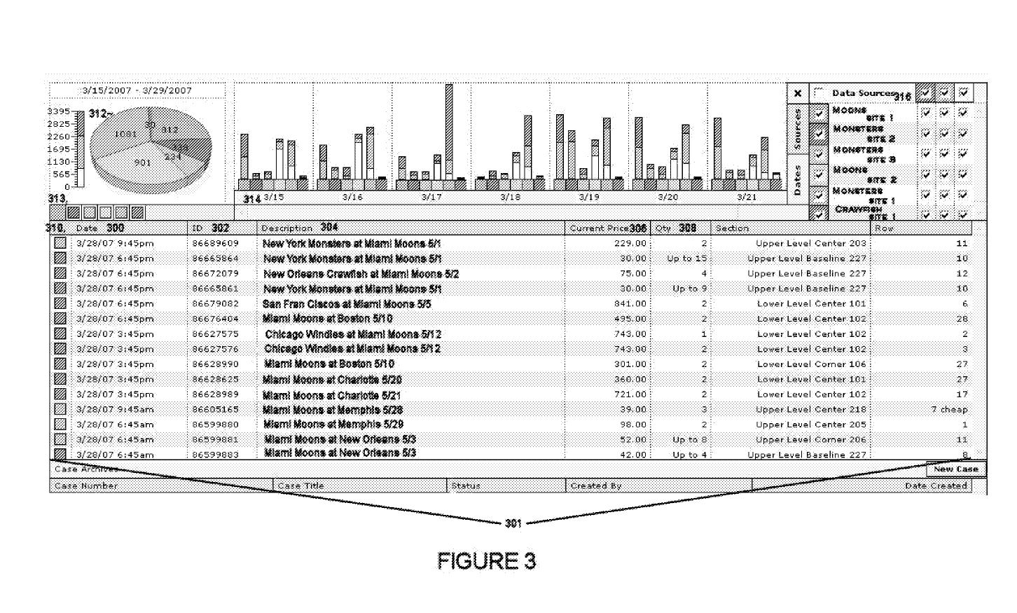

FIG. 3 is an exemplary first output illustrating presentation of auction data stored in a database, according to an embodiment.

A list of auctions is displayed for tickets for all “Miami Moon” games on site one in an individual auction window 301. Each individual auction displayed can be clicked by the user, which will bring up further detailed information about that auction, including any data retrievable from the actual auction site itself, for example: seller's name, seller's address, seller's phone number, seller's email address, seller's web site, item description, opening price, list of bidders and bid history, any associated image files, item description, feedback on seller, etc.

A date column 300 lists a date and time that the auction was started. A date field can also be used which indicates the date and time that the data was last extracted. An ID number column 302 is an ID number of the auction assigned by the e-commerce site hosting the particular auction. A description column 304 is a description of the auction (item being sold). A current price column 306 lists a current price of the auction. A quantity column 308 lists a current quantity of the item that is available. Note that closed auctions are typically also stored in the database as well, and can be displayed or not depending on the user's preferences. Closed auction data is still relevant because a seller's behavior in past auctions may be relevant to the determination of which respective warning level the seller's current auction may be assigned.

A warning level column 310 lists a warning level (or tag or flag) indicating a level of suspicion of each respective auction. Each different warning level can be color coded. For example, dark grey might indicate “highly suspicious,” while light grey can indicate “slightly suspicious” or very light grey can indicate “no suspicion.”

Any individual auction listed in the individual auction window can be selected by the user which can bring up additional more detailed information about that particular auction. For example, Table I below illustrates a sample output of more detailed auction information that can be displayed about an individual auction. Note that the image files an also be displayed. Of course any other information an auction site maintains and makes available to users can be stored and displayed as well.

TABLE I

| | |
|---|---|
| Seller username: | megaseller123 |
| Seller feedback rating: | four stars (excellent) |
| Short item description: | ACME laptop computer model XZ-223 |
| Current bid: | $30 |
| Auction started: | 4/3/2007 3:23 pm |
| Auction closes: | in 23 hours |
| Reserve: | none |
| Seller address: | 4 oak street, Beverly hills, CA 90210 |
| Seller phone # | (800) 555-1234 |
| Long item description: | ACME laptop computer with 20G hard drive, 400 |
| | Mhz processor, 15″ LCD, lots of software, rarely |
| | used. |
| Image files: | laptop223.jpg |
| Warning level: | low |
| Status indicator: | 1 - auction not yet reviewed by user |

A data source window 316 lists different data sources and a product on that data source that the user can click or unclick. A data source in this context means a particular e-commerce site (e.g., such as an auction site e-ray) and auction data relating to auctions for a particular product or products. For example, the first data source is “site 1” (this can be, for example, an e-auction site) and the product is “Moons” (a fictional sports team and the product are tickets for their games). Thus, the first data source are all auctions for Moons tickets that are being held on site 1. If the user clicks (so that there is a checkbox therein) a particular data source, then auctions for the respective product from that data source will appear on the rest of the windows/outputs being displayed. If a particular data source is not checked, then auctions from that data source will not be displayed. The second data source from the top (a dark shade of grey) indicates auctions on Site 2 for monsters (a fictional sports team).

On the top right of the data source window 316 are three warning levels. A user can click or unclick each of these three warning levels. The levels that are clicked will be displayed on the page, otherwise they will not. For example, a user may wish to only see auctions with a high warning level, thus the user would click the leftmost (darkest) box while making sure the other two warning level boxes are unchecked.

The time distribution window 314 illustrates the different tabulations on different days (or other time intervals). For example, the first graph (labeled 3/15) shows horizontal boxes in colors representing all data sources (from the data source window 316). The vertical bars represent the amount of each auction that falls under each warning level. Thus, for example, looking at 3/17, the site 1 monsters auction (since this matches the color of the second bar from the right on 3/17) has a very large amount of dark grey (high warning) auctions.

A pie chart window 312 displays a pie chart showing the distribution of auctions for the given settings (e.g., dates selected) among each of the data sources (e.g., particular e-commerce sites). A histogram also shows the distribution of a number of different warning levels for the auctions in the pie chart.

Therefore, by logging into the “dashboard,” (the display illustrated in FIG. 3), a user can customize his or her view easily by clicking (or unclicking) fields he or she wishes to view. The user can easily see on which dates which auctions have the most suspicious auctions.

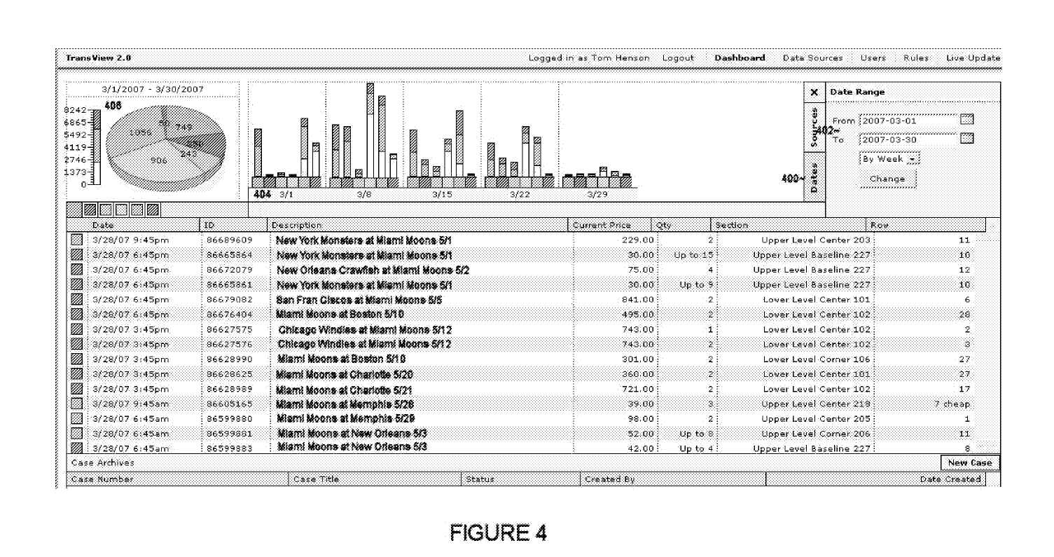

FIG. 4 is an exemplary second output illustrating presentation of auction data stored in a database, according to an embodiment.

A dates tab 400 brings up a date entry window 402 which allows the user to enter a date range for data to be displayed in all of the other windows in the display. The graphs can be displayed based on a temporal duration, e.g., by hour, day, week, month, etc. A time distribution window 404 displays the warning level numbers for each e-commerce site tabulated by week. The warning levels can be color coded, for example, red (or dark grey)=“high level of alert/suspicion,” orange (or medium gray)=“some level of alert/suspicion,” and yellow (or light gray)=“no level of alert/suspicion.” Of course any number of levels can be used with any other type of indicators (e.g., colors, shapes, etc.)

The pie chart window 406 shows a pie chart showing the breakdown between the auctions falling in the designated date range entered in the date entry window 402 and the data sources. A histogram is also shown indicating a breakdown of the different warning levels among those auctions.

Thus, it is apparent from FIGS. 3-4 that a merchant can view how their products are being sold on different e-commerce sites. The display paradigm makes it user for users to identify e-commerce sites that might be more fertile grounds for prohibited or undesirable auctions than others. For example, in FIG. 3, on 3/17, on site 1 the sales of tickets for Monsters have an abnormally high amount of the dark grey (high level of alert/suspicion) warning level auctions.

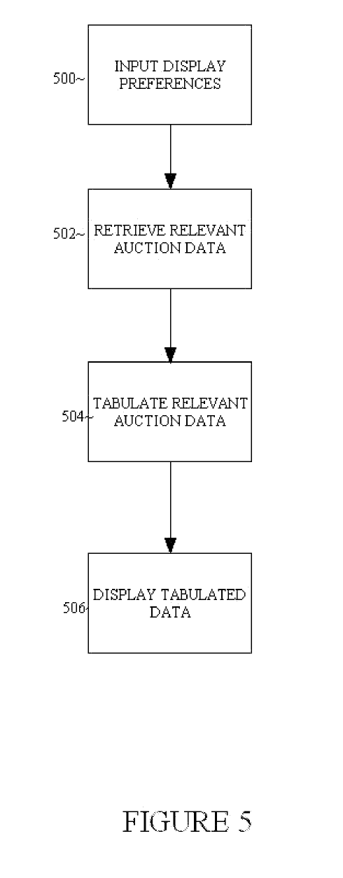

FIG. 5 is a flowchart illustrating an exemplary method of outputting auction data from a database, according to an embodiment.

The method can begin with operation 500, which inputs display preferences from the user. This can be done using a graphical user interface (GUI) and the user can type or click his or her filters of the auction data. The filters narrow what will be displayed. For example, the filters can comprise parameters such as auction date range, input sources, warning levels, etc. For example, a user may wish to see all current auctions for the past month for two different auction sites for two related products. The user can also filter data by other fields as well, such as particular seller(s), particular locations of sellers, price, locations of seats (if the product is tickets), or any other data the database may have.

From operation 500, the method can proceed to operation 502, which retrieves the relevant data from the database. Note that the data the user requests to see is not typically retrieved in real time from the auction sites, but is instead retrieved from the database (which is constantly and automatically being updated by robot crawlers).

From operation 502, the method proceeds to operation 504, which tabulates the relevant auction data retrieved in operation 502 into an attractive and presentable display wherein the user can easily get a visual picture of what he wants to see (see FIGS. 3-4). Any auction data stored in the database can be tabulated and presented in any manner, such as histograms, pie charts, etc.

From operation 504, the method can proceed to operation 506, which displays the tabulated data to the user. Once displayed, the user can refine his or her preferences (e.g., return to operation 500), or perform further functionality on the display, such as clicking individual auctions to bring up more detailed auction information.

In an embodiment, auctions can be shut down. Auction sites such as E-BAY have a mechanism wherein a party that feels an auction is in violation of their rights (e.g., infringes upon trademark rights, counterfeit goods, etc.) can send the auction site an electronic communication so that the auction site can shut down the auction. The auctioneer will receive a communication from the auction site saying that their auction has been shut down and why. The auctioneer will then typically have the opportunity to defend themselves to the auction site and explain why their auction was not in violation of any rule or law. If an auction was shut down erroneously, the auction can be restarted and there shouldn't be any damages since the down time the auctioneer faced was brief.

Rules applied to either determine whether an auction should be targeted for shut down or to determine an appropriate warning level can be set by the users and administers of the software. A flexible and scalable rules system can be applied to allow for application of rules which encompass a large range of data and/or behaviors. For example, when examining an auction in order to determine potential counterfeiting (or other undesirable activity), the following characteristics may relevant and indicative: (a) Sale of particular products associated with a brand's name online but not actually manufactured by the seller; (b) Identification of particular known fraudulent/counterfeit sellers; (c) Identification of pictures taken from a client's website and used on an auction/commerce site; (d) ID of language taken from a client's website and used for the listing of the good; (e) ID of a link back to the client's site; (f) ID of a seller or sellers selling multiple goods in the same listing, in multiple listings, over multiple days/weeks/months; (g) ID of a seller with similar seller feedback as a by known or likely counterfeiters/fraudsters; (h) ID of a seller with the description of goods similar to the description of goods used by known or likely counterfeiters/fraudsters; (i) ID of a picture of a good that has been altered; (j) ID of selling times used by counterfeiters in order to avoid detection; (k) ID of use of non-applicable categories by sellers in order to avoid detection as a fraud/counterfeit; (l) Pricing of goods that are out of line for the type of product being offered; (m) Requirement of payment via a payment mechanism known to be used by fraudsters/counterfeiters.

A secondary ticket market can be an e-commerce site that specializes in selling tickets. In such markets, relevant information which can trigger higher or lower alerts can be, for example, (a) a particular section, row and/or seat numbers of interest; (b) particular pricing trends (e.g. price changes in fashion that is of interest).

Pricing behavior may also be another rule that may be indicative of undesirable behavior. For example, a change in price more than a certain percent with respect to a particular item or set of items might be relevant information. For example a seller lowering his or her price may be indicative that the seller is purchasing his or her goods from another seller that may have also lowered their prices.

Other relevant information that should be reviewed relate to general intelligence. For example, item descriptions can be reviewed to see if they contain particular trademarks which may be a trademark violation.

The present inventive concept can request that an auction site shut down particular auctions in two ways. In a first, the system can automatically flag suspicious auctions that have a level of irregularity higher than a predetermined threshold. These auctions can automatically be communicated to the auction site that will then shut them down. The automatic method does run the risk that some auctions that aren't doing anything wrong may be shut down erroneously. In a second method, the system can generate a list of auctions to take down, but a user would have to manually review each auction summary and decide whether to submit the auction to the auction site for takedown. Since human intervention is required, this method would reduce the amount of erroneous auction shut down, but would also require more human capital to review each suspicious auction manually.

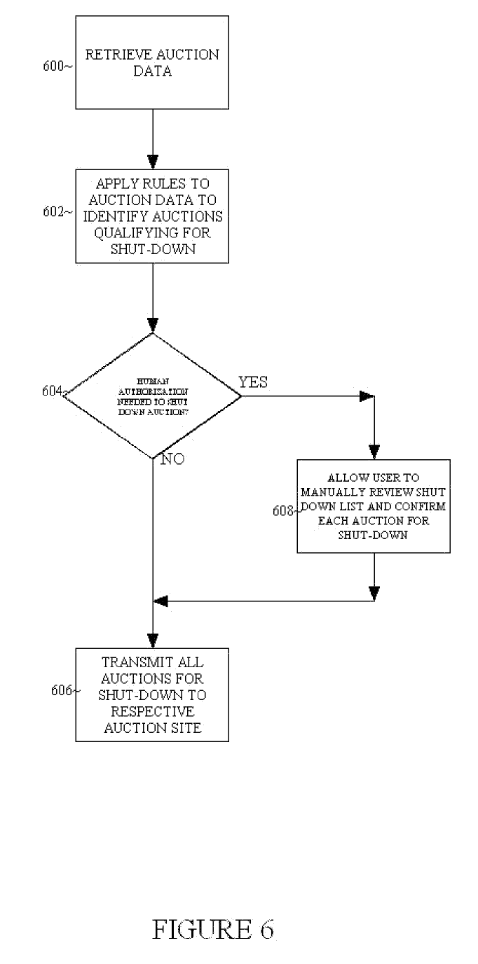

FIG. 6 is a flowchart illustrating an exemplary method of shutting down auctions, according to an embodiment.

The method can start with operation 600, which retrieves auction data. The auction data contains data about individual auctions. This can be done using any method described herein or known in the art.

From operation 600, the method can proceed to operation 602, which applies rules to the auction data to identify auctions qualifying for shut down. The rules would identify characteristics of an irregular auction, and can bet set to trigger an identification for shut down upon meeting of several conditions. For example, if an individual auction contains an item description that would be a certainty that it is a counterfeit item (e.g., selling a type of designer product that the actual designer does not make) then based on this characteristic only this auction can be identified for shut down. Alternatively, if other conditions are met that indicate a suspicious auction, then the auction can be identified for shut down. For example, if the auction contains a price significantly below a market value and the seller has a large quantity of the items (e.g., greater than a predetermined amount) then while none or one of these conditions may not trigger a shut-down, having both present can trigger shut down status. Alternatively, any auction that is given a high warning level (as described herein) can be destined for shut down. Or special rules can be applied to auctions for shut down (as opposed to the other rules to determine which warning level a particular auction should get), since a very high confidence level should be required if an auction is going to be shut down.

From operation 602, the method can proceed to operation 604, which determines whether human authorization is needed to request shut down of the auction(s). Whether this is required or not would just be based on the rules being followed by the user. The user can set these rules in any manner the user wishes.

If human authorization is not needed, the method can proceed to operation 606, which can automatically communicate with the respective auction site of each offending auction (auction targeted to be shut down) all of the information that each auction site would need to shut down each auction. Auction sites can have an automated procedure whereby merchants can electronically communicate information in order for the auction sites to shut down (or suspend) a particular auction. The information may comprises the auction number and a reason why the auction should be suspended. Once an auction is shut down, it is then up to the seller (of the auction) to resolve the issue with the auction site.

If the determination in operation 604 determines that human authorization is needed to request shut down of the auctions, then the method can proceed to operation 608, which allows a user to manually review each auction in a shut down list determined in operation 602 so the user can indicate which auctions should be requested to be shut down and which should not. This extra level of review can help reduce erroneous shut down requests.

In addition to using the information in the seller's auction to determine the appropriate warning level, additional information can be used as well. For example, information about the seller's prior auctions can be used, information about the seller itself can be used, or even information about other seller names that might (but not known) be the seller itself using a different name and their auctions can be used.

For example, sellers of counterfeit goods may use multiple names on an e-commerce site in order to avoid detection or to not arouse attention. Some manufacturers may place restrictions on bulk sales of their products. If a purchaser buys a particular brand of jeans and decides for whatever reason they want to sell them online, the manufacturer typically does not mind. However, a manufacturer may mind if a seller is selling large quantities (e.g., 20 or more) pairs of their jeans. Sellers may attempt to avoid detection by setting up multiple accounts/names and selling large volumes of the products under different aliases. Another scenario in which prior auctions may be relevant to analyzing a current auction is if a prior seller is shut down (and possibly banned from the e-commerce site), the seller may try to set up a brand new account/name. If a new user is registered at a close proximity in time to when a prior user was shut down, this might be indicative that the new user may be the same entity as the prior user.

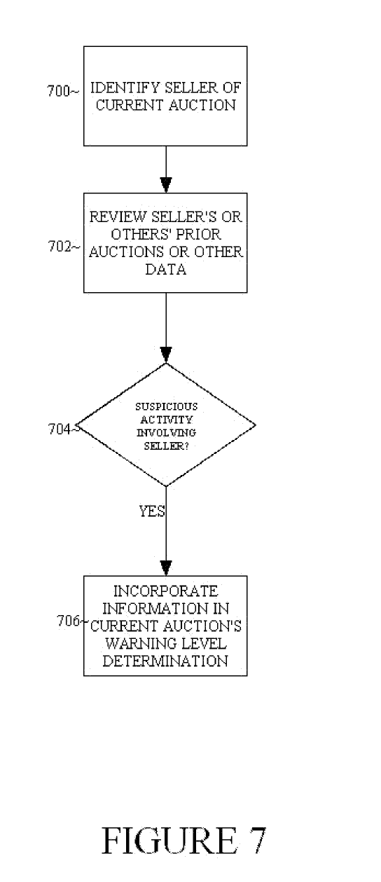

FIG. 7 is a flowchart illustrating an exemplary method of using additional information aside from the seller's auction description in order to apply rules, according to an embodiment.

The method can start with operation 700, which identifies a seller of a current auction.

The method can then proceed to operation 702, which reviews transactions, which can be the seller's other auctions or others' prior auctions, or any other data in the database as well. For example, if a seller's prior auction was shut down for selling counterfeit goods (or other prohibited conduct), then this information may be indicative that the seller has a higher likelihood than the average user to be partaking in prohibited conduct. Other sellers' auctions can be reviewed as well to determine if there is any connection to the current seller. For example, if a description of goods in the seller's auction description is identical or close to a description of goods in another seller's auction description, it may be likely that both sellers are actually the same entity. Transactions can include open auctions (or offers to sell goods at non-auction sites), or closed auctions (or completed sales at non-auction sites), or any other data stored in the database. An auction placed by a seller can also be considered to be a sales offer.

The auction data stored in the database can be reviewed for characteristics according to the rules in use to determine what, if any, relevance other data may have aside from the data relating to the actual auction being analyzed.

Additional data that might be relevant could be user feedback. For example, if a sham seller identity (a new identity/username set up to avoid detection or association with a prior username) is set up, then the sham seller would desire to have positive feedback as quickly as possible. Thus, the sham seller may have a small number of his friends (or even other sham identities the sham seller has set up) buy nominal items from him or her in order that the buy can leave positive feedback. Typically, an auction site would not allow feedback to be left unless a sale was actually completed. Thus, a seller who desires positive feedback can simply close auctions with other sham identities he owns (or other business associates) for the sole purpose of leaving positive feedback.

From operation 702 the method can proceed to operation 704, which determines whether suspicious (or undesirable) activity involving seller has occurred? Suspicious or undesirable activity can be any occurrence based on information external to what is in the seller's auction itself that is indicative of a higher likelihood of suspicious or undesirable conduct on the e-commerce site.

If the determination in operation 704 determines that suspicious or undesirable activity is present, then this information can be used when determining a current auction's warning level (or whether that auction is to be submitted for shut-down).

When auction sites are visited by a robot crawler in accordance with the present inventive concept to extract data to add to the database, the seller information available to the crawler is limited. When visiting particular auction site(s), it may be the site's policy that the site will release more detailed information about the seller to a bidder. Thus, it may be desirable to place nominal bids on some auctions not for the purpose of winning an auction, but for the purpose of gaining more information about the seller. Once a bid is placed, more detailed information about the seller is available which can then be captured by the robot and added to the database.

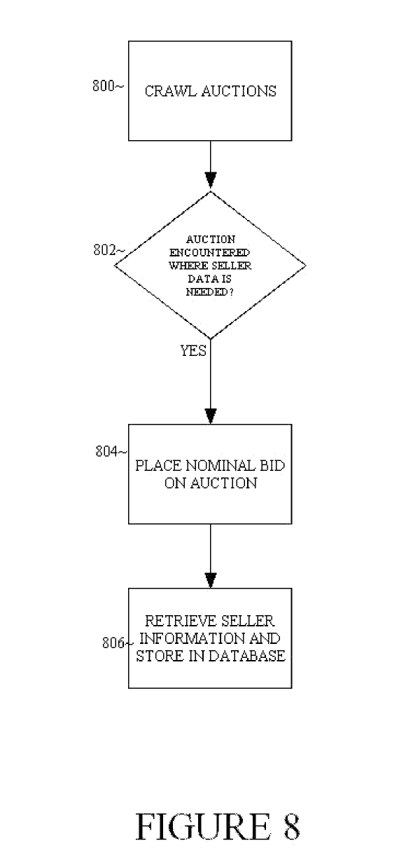

FIG. 8 is an exemplary flowchart illustrating a method of making nominal bids in an auction in order to extract seller data, according to an embodiment.

The method can start with operation 800, which crawls auctions. This can be done as described herein or as known in the art. Each auction on each page can be “clicked” by the robot to retrieve further detailed information about the auction, which can all then be stored in a database.

From operation 800, the method can continue to operation 802, which determines whether an auction is encountered which the seller data is needed. If the database already has information on this seller (for example by making a bid on another one of the seller's auctions), then the seller data would not be needed again. However, if the additional seller data that would be ascertained by making a bid is not available in the database, and it is determined that the seller is relevant to the user, then the seller data would be needed. If the seller is selling a product not related to any products of the user of the system, then there would probably be no reason for the system to need more detailed seller information. However, if the seller is selling products related or relevant to the user of the system, then the seller data would likely be needed.

If the seller data is needed, then the method can proceed to operation 804, which places a nominal bid on the auction. This can be done automatically by the robot by virtually clicking the respective buttons in the web browser and entering the bid amount (e.g, $0.01). If an auction has a reserve price, then placing a nominal bid may not be possible, and to place a bid at the reserve price might not be ideal because the robot may then be forced to purchase the item if nobody outbids it.

From operation 804, the method can proceed to operation 806, which retrieves the additional seller information and now made available and stored it in the database. The seller information can now be available so that other auctions by the same seller do not need to be bid on again.

In a further embodiment, auctions can also have a status indicator indicating a status of a user's manual review of that auction. Table II below illustrates a sample set of status indicators which can all be associated with each auction in the database.

TABLE II

| Indicator | signifies |
|---|---|
| 1 | auction has not yet been reviewed |
| 2 | auction reviewed, no further action taken |
| 3 | auction reviewed, some action taken (e.g., forwarded for |
| | internal investigation) |
| 4 | auction reported |
| 5 | auction removed. |

The indicator number simply represents a particular letter, color and/or appearance that can appear in a status column (not pictured in FIGS. 3-4) that can appear alongside an auction in the auction list displayed (see FIGS. 3-4) and/or can appear when a more detailed view of an auction is displayed. Note that the status indicator is different from a warning level which indicates a level of suspicion that a particular auction is engaged in prohibited or undesirable activity.

An advantage of maintaining status indicators is so that the user of the system can easily keep track of which auctions they have already reviewed manually. With respect to problematic auctions, there are several points in the review process, e.g., a first review, forwarding the auction for additional review, reporting the auction, and ultimately recognizing that the auction has been stopped.

Further, a special status can be assigned to an auction after a predetermined amount of time has passed (e.g., 2 days) since the auction was picked up by the system and awaiting a user review. A different special status can also be assigned after a predetermined amount of time has passed (e.g., 1 day) from when the auction was first reported to the e-commerce site to be shut down. When an auction is removed, a special list can be maintained in the database of removed auctions.

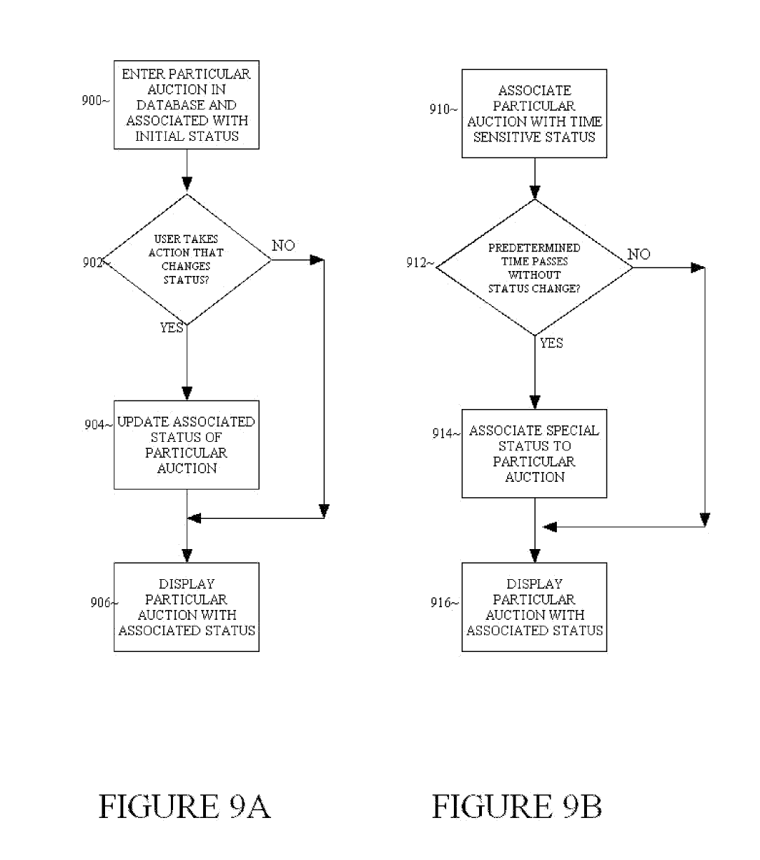

FIG. 9A is a flowchart illustrating an exemplary method of associating status indicators with auctions, according to an embodiment.

The method can begin with operation 900, which enters a particular auction into the database and associates the particular auction with an initial status. Typically, the particular auction will have just been retrieved from an auction site. The initial status can be, for example—auction not yet reviewed.

From operation 900, the method can proceed to operation 902, which determines whether the user has taken an action that changes the status of the particular auction. For example, the user can review the auction and conclude that there is nothing suspicious about it and manually change its status (by clicking icons or any other way using an I/O interface) to status 2, auction reviewed—no action taken. The user can also change its status to any other status, for example if the user finds something suspicious about the auction it can change the status to status 3, auction reviewed—forwarded for internal investigation.

If the determination in operation 902 determines that the user has taken an action that would change the status, then the method can proceed to operation 904 which updates the status of the particular auction to the new status.

From either operations 902 or 904, the method can proceed to operation 906 which can display information about the particular auction (including the auction number, item description, and any other information known about the auction) and the associated status. The displaying in operation 906 does not have to be performed immediately after operations 902 or 904, but can be performed whenever the user enters a query or performs some action that would display the particular auction.

FIG. 9B is a flowchart illustrating an exemplary method of implementing a time sensitive status indicator, according to an embodiment.

The method can start with operation 910, which associates a particular auction with a time sensitive status. For example, if the particular auction was just retrieved from an auction site the user may desire that a reminder be implemented when that auction is not reviewed within a certain time. This option can be configured at the option of the user of the system. Thus, the particular auction can have a status of—auction not yet reviewed. After a predetermined amount of time (can be set by the user, e.g., two days), the auction's status can change automatically to something that would get the user's attention in order so that user would quickly review the particular auction.

From operation 910, the method can proceed to operation 912, which determines whether the predetermined amount of time has passed without a status change. If the predetermined amount of time has passed without a status change (or a compatible action by the user on the particular auction to change its status), then the method can proceed to operation 914.

In operation 914, a special status can then be associated with the particular auction. For example, the special status can be, auction not yet reviewed two days passed. The indicator for this status may be a flashing icon or something that would be likely to get the user's attention. When the user then takes action on the particular auction (e.g., reviews it) the status can then be changed to a new status, such as, auction reviewed no further action taken.

From operations 912 or 914, the method can proceed to operation 916 which can display information about the particular auction (including the auction number, item description, and any other information known about the auction) and the associated status. The displaying in operation 916 does not have to be performed immediately after operations 912 or 914, but can be performed whenever the user enters a query or performs some action that would display the particular auction.

It is noted that the methods described herein can be applied to any type of e-commerce site wherein goods are bought or sold via a computer communications network.

It is noted that any of the operations described herein can be performed in any sensible order. Further, any operation(s) may be optional. Any method described herein also includes hardware needed to implement the method, and also any software that can be stored on a computer readable storage medium which can instruct the hardware to perform the method.

The many features and advantages of the inventive concept are apparent from the detailed specification and, thus, it is intended by the appended claims to cover all such features and advantages of the inventive concept that fall within the true spirit and scope of the inventive concept. Further, since numerous modifications and changes will readily occur to those skilled in the art, it is not desired to limit the inventive concept to the exact construction and operation illustrated and described, and accordingly all suitable modifications and equivalents may be resorted to, falling within the scope of the invention.

What is claimed is:

1. A computer implemented method to display auction data, the method comprising:
automatically visiting at least one online auction site using a robot and automatically retrieving auction data from the at least one online auction site, the auction data comprising individual sales and their respective sales information, and storing the auction data in a database;
receiving sales properties from a user; and
retrieving a subset of the sales data from the database based on the properties and displaying the subset to the user.

2. The method as recited in claim 1, wherein the automatically visiting comprises visiting at least two different online auction sites.

3. The method as recited in claim 2, wherein the properties comprise identities of two different auction sites and the displaying merges auction data from the two different auction sites into a single display.

4. The method as recited in claim 1, further comprising
automatically applying rules to a particular auction in the auction database to determine whether the particular auction has characteristics associated with undesirable activity, and if so, then associating a high warning level to the particular auction; and
displaying the high warning level along with data relating to the particular auction.

5. The method as recited in claim 4, wherein a low warning level can also be associated to the particular auction if the characteristics of the particular auction do not meet a threshold needed for the high warning level.

6. The method as recited in claim 1, further comprising: automatically applying rules to a plurality of the auctions in the auction data to determine an irregular auction list and outputting the irregular auction list.

7. The method as recited in claim 1, wherein the retrieving auction data comprises automatically submitting a keyword search in the online auction site and retrieving all results of the keyword search.

8. The method as recited in claim 1, wherein the properties comprise a particular warning level and the displaying limits output to only auctions associated with the particular warning level.

9. The method as recited in claim 8, wherein the auction data comprises auctions from at least two different auction sites.

10. A computer implemented method to determine suspicious activity on an e-commerce site, the method comprising:
reviewing first data comprising information on a first online sale offer offered by a username on an e-commerce site; and
applying rules to the first data and additional sales data stored in a database to determine a warning level for the first online sale offer, the additional sales data comprising data describing transactions aside from the first online sale offer.

11. The method as recited in claim 10, wherein the applying determines whether there is a correlation between the username and a flagged sale in the additional sales data, the flagged sale flagged as violating or having been suspected of violating the e-commerce site's or merchant rules.

12. The method as recited in claim 10, wherein the first online sale offer is conducted at a different e-commerce site than at least one transaction in the additional sales data.

13. The method as recited in claim 10, wherein the applying evaluates whether the username correlates to a seller involved in another transaction in the additional sales data while using a different username.

14. The method as recited in claim 13, wherein the applying compares a time the first online sale offer was created with times that other transactions in the additional sales data were completed.

15. The method as recited in claim 13, wherein the applying compares a time the seller of the first online sale offer was created with times that sellers of other transactions in the additional sales data were banned or their auction shut down.

16. The method as recited in claim 10, wherein the applying compares item descriptions in the first online auction with item descriptions in other transactions in the sales data.

17. The method as recited in claim 10, wherein the applying compares a price of the first online sale offer to prices of similar or identical goods in other transactions in the additional sales data.

18. The method as recited in claim 10, wherein the e-commerce site is an online auction site.

19. A computer implemented method to retrieve auction data, the method comprising:
automatically visiting an online auction site and automatically retrieving individual auction data for an individual auction;
ascertaining a seller of the individual auction;
determining that the seller is not in a database storing auction data;
automatically placing a nominal bid on an item for auction in the individual auction;
receiving additional seller data from the online auction site; and
storing the additional seller data in the database.

20. The method as recited in claim 19, wherein the seller is identified by the seller's username on the online auction site.
